(19) United States
(12) Patent Application Publication
(10) Pub. No.: US 2011/0313794 A1
(43) Pub. Date: Dec. 22, 2011

(54) Insurance Coverage Validation

(76) Inventor: Rosa M. Feeney, Nesconset, NY (US)

(21) Appl. No.: 12/820,332

(22) Filed: Jun. 22, 2010

(51) Int. Cl. G06Q 40/00; G06Q 10/00

(52) U.S. Cl. 705/4

(57) ABSTRACT

A method of evaluating insurance coverage under a policy of insurance, including receiving first insurance claim information associated with an insurance claim, outputting a representative portion of the insurance policy, receiving second insurance claim information in response to the output representative portion of the insurance policy and generating an insurance coverage record based on the second insurance claim information and the insurance policy. The first insurance claim information includes a claimant identifier and a policy identifier. The policy identifier corresponds to a portion of an insurance policy. The representative portion of the insurance policy being selected by a computer processing device in response to the receipt of the first insurance claim information. The second insurance claim information being associated with the insurance claim. The insurance coverage record identifies whether there exists an issue needed to be resolved for the validation of insurance coverage and identifies if any issues exist.

### TECHNICAL FIELD

The present invention relates to the field of insurance claims. More particularly, the present invention relates to an interactive system and method for validation of coverage under an insurance policy while generating an insurance coverage record.

### BACKGROUND

Insurance companies process and settle insurance claims related to a variety of different insurance policies. An insurance claim represents a demand by an insured of their rights under an insurance policy. Such rights generally entitle the insured to benefits under the insurance policy, for example reimbursement of expenses, monetary compensation or legal defense or indemnification. Some of the common policies for which claims are made include Motor Vehicle, Homeowner and Life Insurance policies. If it is determined that the insurance claim is valid, then it is said to be a “covered claim.”

Upon presentation of an insurance claim under any insurance policy, one of the first tasks generally completed by the insurance company is to determine whether facts and circumstances of that claim entitle the person making the claim to benefits under the policy of insurance. The task is usually assigned to an insurance company representative, also referred to as a claims handler or adjuster, whose job it is to evaluate claims that are presented.

The task of verifying or evaluating and analyzing whether or not a claim is covered, and thus falls within the parameters defined by the insurance policy, is also referred to as “validation” of an insurance claim. Validation includes the process whereby the facts of a claim are reviewed or compared against the terms, conditions, exclusions and provisions of the insurance policy and evaluated in order to determine whether or not there is applicable insurance coverage under the policy of insurance. Such validation can often involve a complex analysis. One significant element that contributes to the complexity of the analysis is the insurance policy itself. Also, more than one insurance policy may even be involved. Further, the process of claim(s) validation is made even more complicated by government rules and regulations that restrict or mandate provisions of those policies. Add to this that judicial or legal interpretation of the terms used in those policies, rules and regulations vary by jurisdiction. Due to the complexities of validating coverage of a claim, the claims handlers must not only use analytical and logical thinking skills, but must also maintain extensive knowledge regarding their company's insurance policies, as well as any applicable rules, regulations and interpretations under applicable laws of the pertinent jurisdiction.

Many factors can affect the proper and accurate evaluation of whether a particular claim is covered under a policy of insurance. Insurance contracts often contain complex and lengthy terms, conditions and exclusions, which must be reviewed and analyzed to determine whether insurance coverage exists under a particular policy of insurance. The individual analyzing coverage under the policy must be capable of not only reviewing, understanding and analyzing the policy of insurance; they must also know what further information or investigation is needed to properly evaluate coverage under a policy of insurance. Every claim has a different set of facts, which must be investigated by the claims handler. Knowing what issues to investigate or what additional information is needed is important for a complete and accurate coverage investigation. However, due to the complexity and the high expertise required, the process of claims validation often yields varied results depending on the skill level of the claims handler. The skill level of the claims handler and their knowledge of coverage provided under the particular policy of insurance will also affect whether the policy is properly read and analyzed. All too often the end result of the insurance coverage analysis and validation leads to inconsistent or improper results due to human error.

The failure to properly evaluate and analyze coverage produces enormous financial losses for the insurance industry, world-wide, and reduces the profitability of the insurer. If a claim is presented, which should not have been covered by the insurance policy, the insurance company, and ultimately the ratepayer, will bear the cost of the failure to identify the lack of coverage under the policy. On the other hand, the improper denial of a valid claim affects the insured and innocent third-parties and often leads to years of litigation and enormous litigation costs. Again, these costs are ultimately born by the ratepayer.

While insurance companies use computer-based and knowledge-based claims-processing systems to process claims, such systems are generally limited to methods of managing claims and records, identifying fraudulent claims or estimating legal compensation values. For example, databases are used to assist claims handlers in settling claims by tracking costs and estimating how much money can be offered to a claimant based on injuries sustained as part of an insurance claim. Other systems help manage legal or medical bills processed by the insurance companies related to those claims.

Accordingly, it would be desirable to provide a system and method of evaluating insurance coverage that overcomes the shortcoming of the prior art. Preferably, such a system and/or method is easy to use and provides consistent and accurate results.

### SUMMARY

According to aspects described herein, there is disclosed a method of evaluating insurance coverage under a policy of insurance. The method includes receiving first insurance claim information associated with an insurance claim. The first insurance claim information includes a claimant identifier and a policy identifier. The policy identifier corresponds to at least one portion of an insurance policy. The method also includes outputting a representative portion of the insurance policy. The representative portion of the insurance policy being selected by a computer processing device in response to the receipt of the first insurance claim information. The method also including receiving second insurance claim information in response to the output representative portion of the insurance policy. The second insurance claim information being associated with the insurance claim. Further, the method including generating an insurance coverage record based on the second insurance claim information and the insurance policy. The insurance coverage record identifies whether there exists an issue needed to be resolved for the validation of insurance coverage and identifies if any issues exist. It should be understood that the above methods could be performed by a system including a computer processing device.

In accordance with further aspects disclosed herein, the first insurance claim information can include an indication of a type of claim to which the insurance claim applies. Also, the representative portion of the insurance policy can be rephrased and presented in the form of a question. The representative portion of the insurance policy can include at least one Exclusion, Term, Condition, Provision, Policy Endorsement or Definition, as reflected in the insurance policy. The representative portion of the insurance policy can also include or incorporate at least one judicial decision, regulatory or statutory authority or guidelines pertaining to the insurance claim. The second insurance claim information can be at least partially responsive to the rephrased output representative portion of the insurance policy.

In accordance with further aspects disclosed herein, the generated insurance coverage record, also referred to as “the record”, may include a warning or basis for denial of the insurance claim. The record may indicate no valid basis for denial of the insurance claim. Also, the record can include a list or summary of compiled details regarding the insurance claim. The list or summary may identify a form, document, or written communication needed for the validation of insurance coverage. The record may also include actual copies of the needed form, document or written communication. The identified issue can include at least one factual issue or at least one legal issue for further inquiry or investigation. Further, the identified issue can include a basis for consulting legal counsel. The record can additionally include an assessment of the responses received from the queries. The assessment can include an indication of how the queries were answered. The record can be used for auditing or monitoring the insurance claims representatives performance and/or evaluation of coverage under the insurance policy for a particular insurance claim. Also, the record can be used for training an insurance claims representative. Additionally, the record can be used for different insurance claims. The record can include information based on a determination of at least one of legal precedent and guidelines altering the interpretation, at least in part, of a portion of the insurance policy.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 illustrates a flow chart of a method of evaluating insurance coverage in accordance with an aspect of the disclosed technologies.

FIG. 2 illustrates an exemplary output display presenting a question to a user for receiving claim information.

FIG. 3 illustrates a further flow chart of a method of evaluating insurance coverage in accordance with an aspect of the disclosed technologies.

FIG. 4 illustrates a further exemplary output display presenting a question to a user for receiving claim information.

FIGS. 5a and 5b illustrate a comparison of literal portions of an insurance policy translated into user queries, in accordance with aspects of the disclosed technologies.

FIG. 6 illustrates an exemplary log generated in accordance with an aspect of the disclosed technologies.

FIG. 7 illustrates a further exemplary log generated in accordance with an aspect of the disclosed technologies.

### DETAILED DESCRIPTION

Describing now in further detail these exemplary embodiments with reference to the Figures, as described above the accurate sheet leading edge registration system and method are typically used in a select location or locations of the paper path or paths of various conventional media handling assemblies. Thus, only a portion of an exemplary media handling assembly path is illustrated herein.

As used herein, “an insurance policy” refers to a contract of insurance which provides defense, indemnification and/or other payments in the event that a risk covered by the insurance policy occurs. The policy of insurance is made up of Terms, Conditions, Insuring Agreements, Definitions and Exclusions. Examples include life, health, automobile, homeowners, and commercial insurance policies. Additionally, the insurance policy as referred to herein can include other extraneous forms or documents incorporated by reference therein or read into the policy by operation of law. Also, a “representative portion of the insurance policy,” refers to and includes a portion, segment, endorsement or other provisions of an insurance policy which are applicable to a particular claim. A representative portion also includes controlling laws, statutory or regulatory provisions, and judicial case law that interpret those laws or provisions.

As used herein, “a policy identifier” refers to information such as the policy number and insured and other information necessary in order to identify the applicable policy of insurance and all applicable endorsement, provisions, conditions, exclusions and terms applicable to the particular policy of insurance.

As used herein, an “insurance claim” or just “claim” interchangeably refer to a demand by an insured for coverage under an insurance policy and/or a demand by a third-party for compensation from the insurer. Such rights generally entitle the insured to benefits under the insurance policy, for example reimbursement of expenses, monetary compensation or legal defense or indemnification. Also, as is customary in the art, use of the expression “the loss” is often interchangeable with the claim. The “loss” generally refers to an event that caused some tangible or intangible loss or damage that one or more claimants sustained. A single loss could initiate multiple claims from a single claimant and could also include multiple claimants with different claims.

As used herein, “insurance claim information” refers to information that identifies a claim and the pertinent, applicable portion of the insurance policy. This includes a claim number, insured name, policy number, date of loss, claim or occurrence details, claimant(s) information and the applicable endorsements, forms or other tangible records, documentation, forms or writings which comprise the insurance policy. Also, this information can identify more than one claim and the pertinent, applicable portion(s) of the insurance policy.

As used herein, “claimant identifier” refers to information necessary to identify the claimant including the claimant's representative, if any, who has presented a claim to the insurance carrier. The claimant identifier can include the name and address for the claimant and any representative of the claimant in connection with said claim.

As used herein, “an insurance coverage record” refers to at least one compilation or account of information or facts set down, registered or indicated for preservation, in writing or other tangible form, such as in a document, log, register or report. An insurance coverage record refers more specifically to a compilation or account of information or facts pertaining to the verification of applicable insurance coverage.

As used herein, the expression “a sequence and series of questions” refers to queries which are grouped and/or asked in an order following one another, but not necessarily immediately or directly following one another. These queries are intended to elicit a response required for the validation of insurance coverage under the policy of insurance. The sequence or series of questions can be derived from the applicable portion of the insurance policy, judicial or legal interpretation of insurance policy terms or provisions, applicable rules and regulations.

In accordance with an aspect of the disclosed technologies it has been determined that insurance claim validation could be improved by developing and providing an automated system, which through a sequence and series of interactive questions assists and guides a user, such as a claims handler or other interested entity, to identify coverage issues that are significant in the evaluation of an insurance claim. The system and/or method preferably determine whether coverage validly exists for a claim under a policy of insurance.

An aspect of such a system guides the user through questions that should be answered in order to properly evaluate coverage under the policy of insurance and automates the process. Such a system can reduce inconsistencies in the evaluation of coverage and prevents or minimizes improper validation of insurance coverage under an insurance policy.

The presently disclosed technologies include methods and systems for evaluating insurance coverage associated with an insurance claim under a policy of insurance through a sequence of interactive questions, at least a portion of which are generated from portions of an insurance policy. An aspect of the disclosed technologies is a system and method that guides a user through the numerous inquiries that need to be addressed in order to properly and thoroughly evaluate coverage under a policy of insurance. A person interested in evaluating an insurance claim, such as an insurance claims handler or manager, simply needs to respond to as many of the questions presented to them as they can. At one point, those questions will include an excerpt of pertinent insurance policy claim language. Each of such excerpts is referred to herein as a “representative portion of the insurance policy.” The representative portion of the insurance policy includes text directly from the pertinent policy or extraneous text not necessarily included directly in the insurance policy, but is relevant to and/or pertinent to the interpretation of the insurance policy. As the interested person responds to the questions, a record is generated that can be used to document, assess and thus evaluate the insurance claim. The record can identify and/or indicate whether there exist any issues that need to be resolved for the verification of insurance coverage.

While insurance claims can be quite diverse, as an example, the claims associated with an automobile accident are discussed in greater detail herein. It should be understood that a similar procedure and system in accordance with aspects of the disclosed technologies herein can be used for other forms of insurance claims. Typically, when personal injury or property damage is sustained as a result of a motor vehicle accident, an insurance claim is presented to an insurance company. However, such an insurance claim can implicate more than one insurance policy and depending on the circumstances of the accident and the people involved, may implicate different parts of any implicated policy. Also, the type of insurance coverage implicated under an insurance policy may depend on the type of claim presented. For example, a motor vehicle accident might trigger an insurance claim for property damage, medical costs or other expenses, lost wages, pain and suffering, or even defense or indemnification of an insured, any of which stemmed from that accident. Once an insurance claim is presented, the claims handler or evaluator needs to identify the type of claim being presented and make a determination as to whether the policy or policies of insurance provide insurance coverage for the type of claim being presented. For example, a motor vehicle accident might trigger coverage under the collision coverage, no-fault coverage, liability coverage or uninsured/underinsured motorist coverage of a particular policy. Then, once the type of coverage is determined, the terms, conditions, exclusions or other provisions of the subject insurance policy would need to be analyzed in order to determine whether to provide or preclude coverage for the claim.

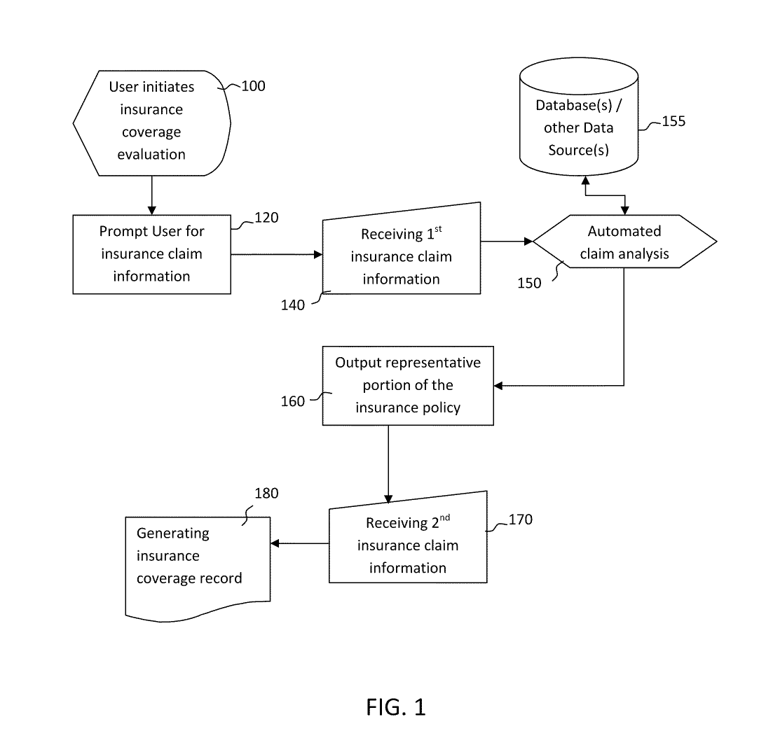

Methods and systems consistent with the present invention enable the claims handler or evaluator to identify the type of claim being presented and then proceed to evaluate whether the insurance policy provides coverage for the type of claim being presented. With reference to FIG. 1, a claims handler, evaluator or other interested entity is referred to as a “user” of the system that implements the disclosed methods. In step 100, the user initiates the insurance coverage evaluation process, which includes accessing the automated systems disclosed herein for processing the claims.

Initiating the process 100 may involve a stand-alone user interface terminal or a networked application. The interface terminal can be a stand-alone computer, on one or more computers communicating through a local or remote network or any other configuration as is desired and known in the art. As referred to herein, a “computer processing device” or just “computer” refers to a programmable machine that receives input, stores and manipulates data, generates records and provides output in a useful format. It being understood that a computer works in conjunction with a computer-readable storage medium that is local or remote to a particular interface terminal. Initiating the process 100 could involve logging into a web site or utilizing a local or remote program, software or other computer based system. The system then prompts the user as part of a process of presenting interactive questions to that user. The questions relate to information needed from the user regarding the insurance claim. A computer network or network of computers, also referred to as a network (local or remote), is a collection of computers and devices connected by communications channels that facilitates communications among individual computers and users and allowing them to share resources.

Once the user has initiated the process at 100, the system will prompt the user for insurance claim information at 120. When the user enters one or more responses to those questions, the system is said to receive at 140 those responses for processing and analysis. Initially the received information should identify the claimant and a policy identifier. Also, such a policy identifier should correspond to at least one portion of an insurance policy. It should be understood that as is common with contemporary interactive computer systems, the system can either immediately analyze the information as it is entered by the user or wait for the user to hit ‘Enter’, ‘Save’, ‘Next’ or some other indication from the user before an analysis is initiated. Once at least some insurance claim information is received, the system can begin an automated analysis thereof at 150. Such an analysis can be done by one or more operating systems, including databases or other data sources 155. The databases or other data sources 155 can be a stand alone system or a collection of systems that work together to provide access to up-to-date, accurate information. Preferably, the databases or other data sources 155 are compiled and designed to operate in a way that provides correct and complete information for assisting in the claims analysis process. After at least part of the claim analysis is complete, the system can output a representative portion of the insurance policy at 160. The output representative portion of the insurance policy is thus selected by the computer in response to the earlier received insurance claim information. Such an output can take the form of a question, but should at least be understood by a user to represent a further inquiry in the sequence and series of questions used in the pending claims analysis. By responding to the output representative portion of the insurance policy, the system will receive further insurance claim information at 170. As with 140 above, the steps 140, 170 of receiving information can be done as part of a single set of questions presented to the user at one time, or multiple sets of questions presented separately, as desired or needed for a particular claim. The information received can vary from detailed information, such as names, numbers or descriptions of things to less detailed responses, like “yes”, “no” or “undetermined.” Preferably, the questions solicit the user to enter any notes for information pertinent to the inquiry. In another embodiment, the user will have the option of entering brief or detailed written responses to the inquiry generated. Throughout the steps noted above, the claims handler or the system itself can save the information compiled and end the process if desired. One aspect of the disclosed technologies allows such saved information to be accessed for future use and/or reference by that initiating user or other authorized users.

An aspect of the disclosed technologies herein creates a record based on the claim information entered in response to the queries presented to the user. Thus, at 180 an insurance coverage record is generated based on the insurance claim information collected. In particular, the second insurance claim information, in response to representative portions of the insurance policy, is useful in creating a thorough record. It is preferred that the record identify whether there exists at least one issue that needs to be resolved for the verification of insurance coverage. Also, if one or more of such issues exists, the record should identify such issues. Additionally, if no such issue exists, the record should reflect that conclusion.

The automated analysis 150 preferably considers the particular terms of the subject insurance policy, as well as other controlling legal authority. The analysis can reduce inconsistencies in the evaluation of coverage and allow even the unskilled claims evaluator to conduct a proper and thorough claims analysis. Also, by having the most common inquiries that must be made automatically generated, the claims handler responds to these questions, which are designed to make the relevant inquiries, which must be answered in order to perform a complete and thorough analysis of whether insurance coverage exists for the type of claim being presented. This process maximizes the possibility that pertinent inquiries are made and that the facts of the loss or claim are investigated and properly analyzed against the policy provisions and the applicable case law, statutory and regulatory authority or other law. For example, in a motor vehicle accident claim, the methods and systems consistent with the present invention, through a methodical and logical process, will inquire whether the person claiming coverage is an insured under the policy and whether any policy exclusions apply to the accident. After answering a sequence and series of questions specifically based upon the insurance policy in question, the claims handler or evaluator will be able to identify any potential coverage defenses under the policy and determine whether further inquiry or investigation is needed to determine whether any coverage defenses apply to the claim.

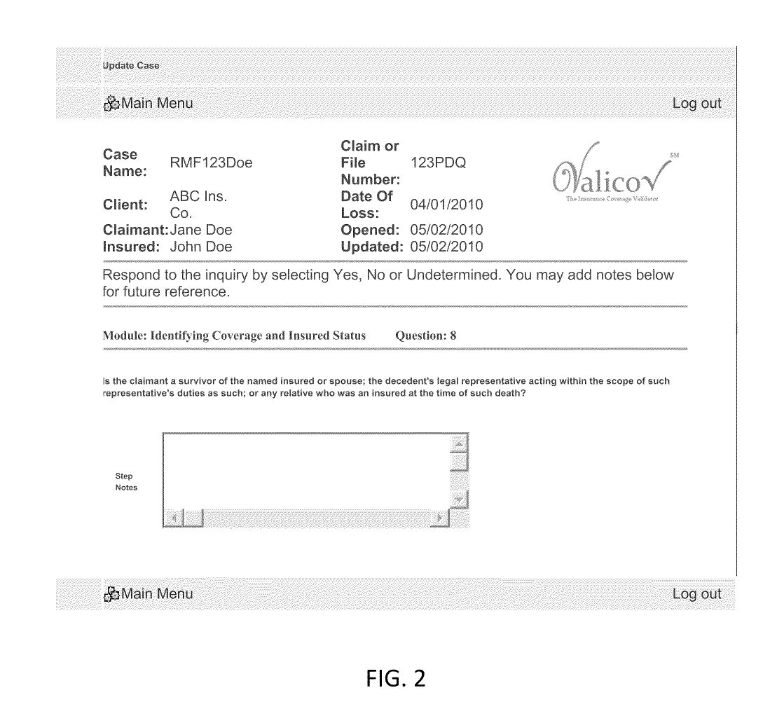

The process of starting a new claim or adding information to an existing claim is considered part of the process where the system receives claim information 140. FIG. 2 illustrates an example of a user interface, where the user is being prompted for information about the claimant. In the example, the question is the 8th question in the sequence and series of questions presented to the user. Such an inquiry could be considered preliminary insurance claim information (also referred to herein as, “first insurance claim information”). When starting a new claim, the initial inquiries can involve entering or being assigned a file or claim number. When entering further information to an existing claim, the initial process may involve accessing previously saved information for the existing claim and then answering further inquires. When prompting the user for information, as shown in FIG. 2, the display can include case name, client, claimant, insured, date of loss, as well as when the claim was opened and last updated. This type of claim identification information is useful to inform or confirm to the user, on which file information is being entered and analyzed. It should be understood that the preliminary claim information displayed at the top portion of the screen in FIG. 2 is used for case identification purposes and is not intended as a complete list of information obtained at that stage of questioning. This type of user interface could be supplemented by other user-friendly features, like navigation tabs/links (linking to other parts/questions of the analysis), pop-up windows or a status bar advising the user what percentage of the analysis is complete. Step 140 generally involves the system receiving information that identifies a claim. Optionally, the user could select from existing information or parameters used in the business process to identify the claim and further supply the information necessary for the further processing of the claim.

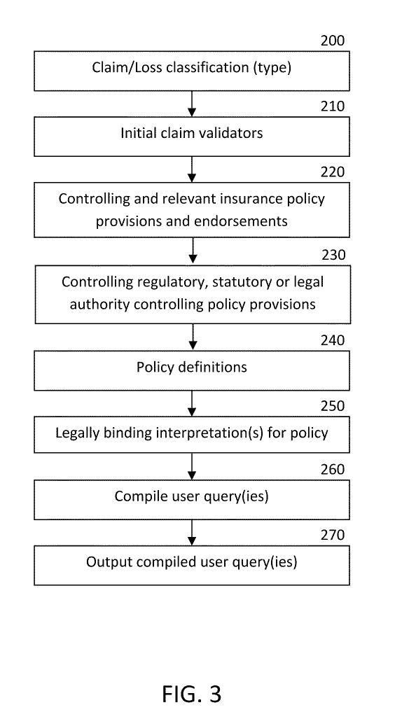

FIG. 3 shows an example of how the system can perform the automated claim analysis noted above. It should be understood that the steps illustrated in FIG. 3 can be performed in almost any desired order and not necessarily the order shown. Also, many of the steps shown in FIG. 3 can be performed simultaneously. Often as a preliminary stage of claims analysis, the claim will be classified 200 in order to limit the pertinent issues for that type of claim that need to be considered. Also, differentiating claims by type can assist in subsequent analysis of similar or related claims. The classification 200 can range from any variety such as liability, uninsured motorist, underinsured motorist, no-fault, collision, property damage, life insurance, marine insurance, commercial general liability, professional liability, to even a more narrow class by jurisdiction, such as New York No-Fault or New York Underinsured Motorist or by the particular insurance policy endorsement form number which is being analyzed. While the user can be allowed to make-up his or her own classification of claims, it is often preferred to provide choices (such as in the form of a drop-down menu) from which the user can select in order to maintain consistency and limit the classification of claims.

Next at 210 the system can determine initial claim validators. Initial validators are those quick and easy questions that can almost immediately rule out coverage under the identified insurance policy. For example, if the claim or loss does not fall within the applicable policy period or whether the policy had been cancelled prior to the date of loss. These initial validators 210 generally involve less complex analysis, and can thus be helpful in quickly determining whether coverage is likely available or not. Occasionally, circumstances arise were even these simple initial questions cannot be easily answered. For example, questions may arise about whether a policy of insurance was properly cancelled. Thus, even though a company's records may show no valid policy existed at the time, such a determination could be inaccurate or not fully verified. The system can address such issues by asking somewhat redundant questions with regard to certain issues or simply allow a user to return and change answers previously entered for a particular claim. Regardless, it is often desirable to address these initial validators first in order to speed-up the evaluation of claims.

In step 220, the process determines which insurance policy provisions and endorsements control and are relevant to the claim. The limiting of relevant provisions and/or endorsements could be selected by the user or performed automatically by the system. Often the relevant provisions can be determined from an insurance policy declarations page, which lists the applicable policy endorsements. If maintained in an accessible database or data file, this information could be used in an automated way to compile these elements. It should be emphasized that the initial claim validators 210 can be assessed before, after and throughout the compilation of these or other elements described herein. Particularly, since often answers to subsequent questions can require that certain issues or policy provisions be reassessed. Additionally, certain insurance policies or provisions may have regulatory, statutory or other legal authority that is controlling, depending on the jurisdiction. In step 230 the system can assess whether there is any such controlling regulatory, statutory or other legal authority that controls. Regulatory authority refers to rules proscribed by government or other authorities, particularly in this context those regulations directed to controlling how insurance claims are handled. Statutory authority relates to one or more laws, decrees or enactment passed by a legislative body and expressed in a formal document. Other legal authority is the catch-all for any other binding authority that influences or controls one or more aspects of how insurance claims are handled. Most commonly, legal authority is derived from formal rulings or decisions by judiciary in the form of case law.

Another part of the analysis involves compiling pertinent definitions 240 of the determined policy provisions and endorsements from 220 and even terms from the controlling regulatory, statutory or legal authority from 230. Often insurance policies, as with many contracts, have terminology that is given an intrinsic definition. Such definitions affect the analysis of many claims and can be considered as part of the analysis. Additionally, the system can consider, as in 250, legal authority that may be binding on the interpretation of the applicable policy language or how that language is applied to claims. Thus, legal authority can sometimes add or over-ride provisions to an insurance policy, but also interpret provisions used in such policies. Accordingly, the process and system herein can compare the language in the pertinent policy of insurance, including the Introduction, Insuring Agreement, Definitions, Exclusions, Conditions and other policy terms and notify the user of the discrepancies with the pertinent statutory and/or regulatory authority or other laws, if any.

Once at least some of the pertinent insurance policy or other controlling provisions have been determined, the system can compile in 260 one or more queries that need to be answered by a user, such as a claims handler. Such queries are the sequence and series of questions referred to above. As these queries are compiled or perhaps after all or a certain percentage of them are compiled, in 270 the queries can be output to a user. Such an output generally involves a display on a computer terminal or printing onto paper, but any means of communicating the queries to a user will suffice.

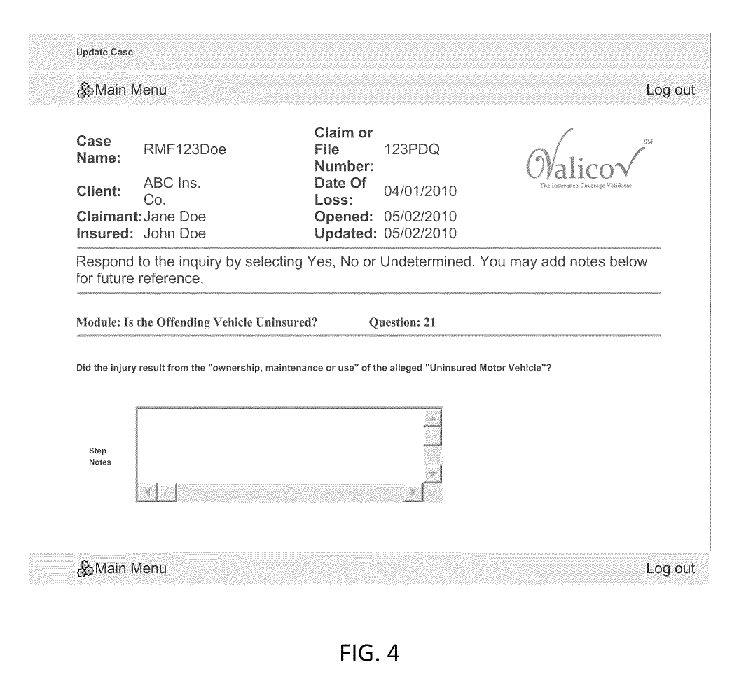

Some of those queries output in 270 will include generic questions that relate to many varied insurance policies. However, other queries will include one or more representative portions of the insurance policy applicable to the claim. In this way, the system does not mischaracterize the actual policy language. Alternatively, the representative portion of the insurance policy could be minimally altered to present it in the form of a question. For example, where a policy provision reads, “The injury must arise from the ownership, maintenance or use of a motor vehicle,” the representative portion of the insurance policy could be presented as a query reading, “Did the injury result from the ownership, maintenance or use of a motor vehicle?” as shown in FIG. 4.

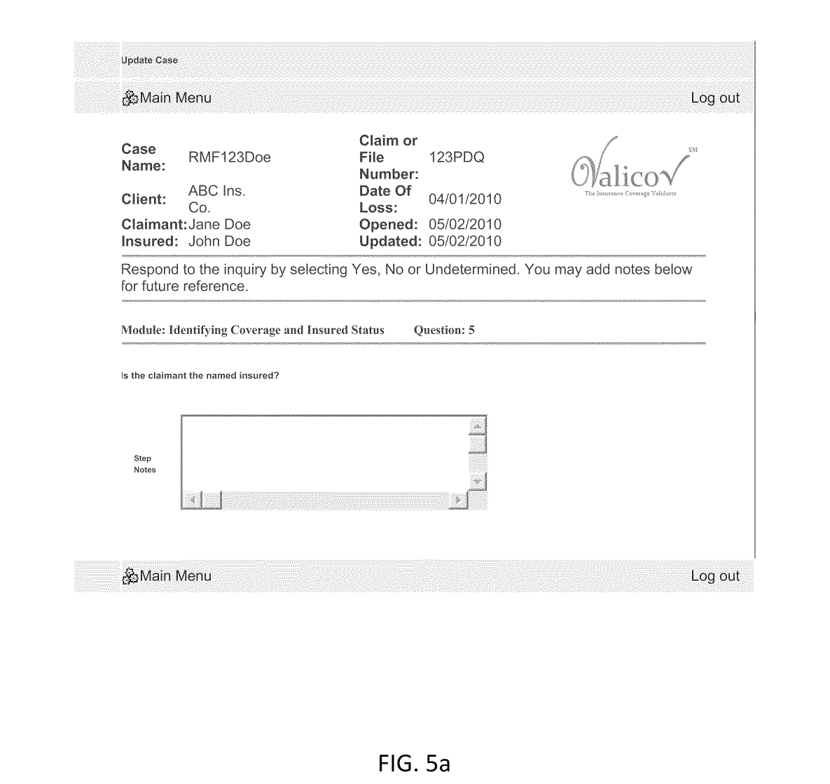

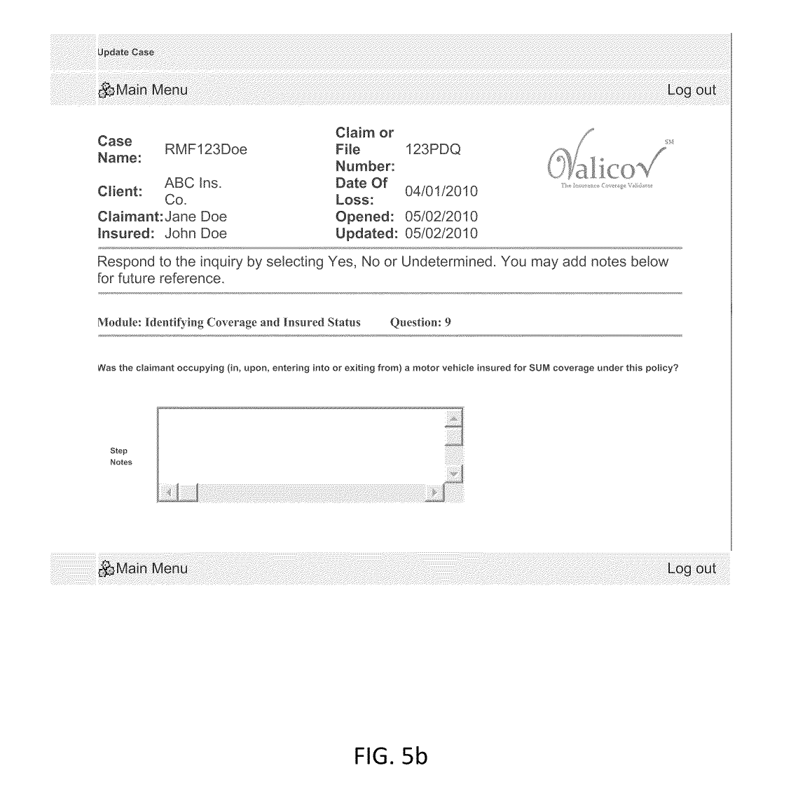

Alternatively, the output query in 270 can include questions that are worded very differently from the policy, but which are designed to solicit an answer that addresses that policy provision or even more than one policy provision combined. FIG. 5a shows an example of a query output to a user that may look different from what is presented in the policy, but which solicits an answer that directly relates to the provision. The following is an example of a portion from the ‘Definitions’ section of a Supplementary Underinsured Motorist (SUM) automobile insurance policy endorsement that relates to the query shown in FIG. 5a:
Definitions: For purposes of this SUM endorsement, the following terms have the following meanings.
   (a) Insured. The unqualified term “insured” means:
      (1) you, as the named insured and, while residents of the same household, your spouse and the relatives of either you or your spouse.
      (2) any other person while occupying:
         (i) a motor vehicle insured for SUM under this policy;
            By asking whether the “claimant is the named insured,” the output query in FIG. 5a can validate that the claimant is one who is properly covered by the subject insurance policy, namely the insured himself, which is covered under the definition of “insured,” subparagraph (1).

FIG. 5b shows example of a query output to a user that combines more than one provision of a policy, in order to solicit an answer that helps verify coverage under the subject policy of insurance. The query in FIG. 5b is derived from the sample definition of “insured,” shown above, combined with the following definition from the insurance policy:

(d) Occupying. The term “occupying” means in, upon, entering into, or exiting from a motor vehicle.

Having performed all or part of the above analysis, the systems and methods described herein can receive first insurance claim information from a user and then output a sequence and series of statements or questions in order to receive further details regarding a claim from the user. In this way, the system can generate an insurance coverage record that can be used to assess whether a claimant is entitled to insurance coverage for a particular claim under a particular policy of insurance.

The insurance coverage record (also referred to herein as the “record”) indicates how the statements were answered; what questions remain open and/or need to be investigated by the evaluator; identify potential coverage defenses or issues under the policy of insurance, and identify forms and documents that can be used for the further handling of the claim or the analysis. The generated insurance coverage record can include information, documents, text, logs and notes that can be analyzed and/or reviewed immediately or can be saved for future reference, such as for updates, audits, including a compliance review. For example the record can be saved into a main electronic file for the claim, one or more linked files that are associated with the claim, a local user file or almost any type of file saving configuration or system, including printing or recording the information in a format that is useful. The record can even include links, such as one or more electronic hyperlinks, to further associated information or reference material.

In one embodiment of the disclosed technologies, the process of presenting a sequence and series of questions can be driven by the user, such that they can select which parts of the analysis to do and in which order. They might chose to conduct an analysis based on a particular insurance policy endorsement. Alternatively, the automated system could display or otherwise output a list of applicable insurance policy endorsements, and the user can select the order in which to address each endorsement. It can be useful for the system to group the questions presented to the user by what section of an insurance policy the questions were derived. Alternatively, an automated processing system can be used to determine an order in which endorsements and/or particular questions should be addressed. For example, any introductory clauses or provisions of the policy endorsements can initially be addressed, followed by other sections or portions such as the Exclusions, Conditions or others.

The record can have various aspects for assisting a user in validating a claim. Some of those aspects of the record include a log of question presented, answers provided or outstanding questions/issues. Also, a log indicating basis of denial of a claim or possible basis. Another aspect of the record include documents used or needed to handle the claim, such as forms, letters, a summary or outline of the claim. Yet another aspect of the record can include case law, reference to statutes, regulations or other applicable authority or law.

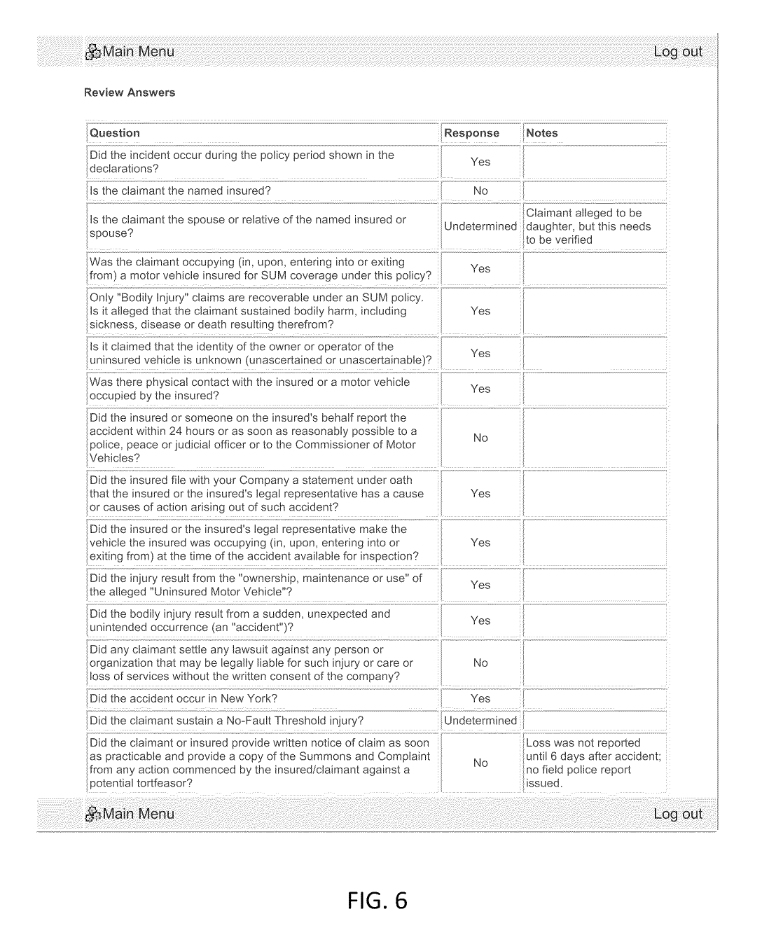

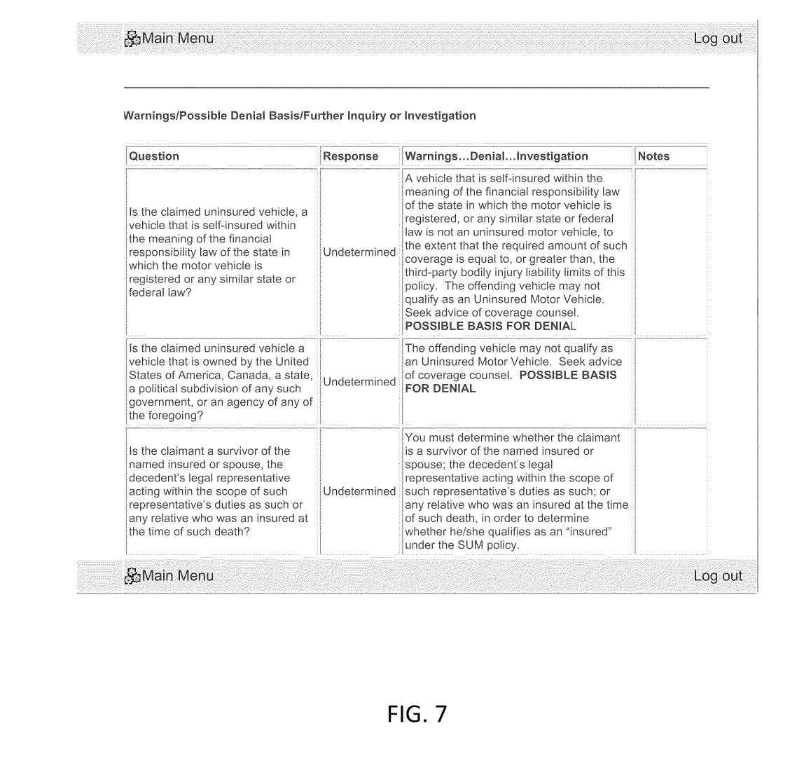

Logs are generated reflecting the input into the program or process. Also, logs are generated as part of the coverage verification process. As referred to herein, logs comprise a systematic record of the claim validation process including things presented to the user, data entered by the user and results of the analysis. Thus, a log can reflect all the questions presented to date with regard to a particular claim and/or all the input provided by one or more users with regard to a claim. Additionally, the log can include user notes either added during the interactive process or at any other time. FIG. 6 shows an exemplary log generated by the methods and systems described herein. In particular FIG. 6 illustrates the Question and Answer log according to one embodiment. Similarly, a log can reflect questions not yet presented or answers not yet completed with regard to a claim. Further, a log can reflect issues or questions that require further resolution or additional inquiries needed to be made by the claims handler. Another aspect of the logs includes a record of any basis of denial or possible basis that is applicable to a claim. The log can include warnings the user must consider for the proper validation of the claim. Further a log can reflect forms or documents which can be generated as part of the insurance validation process. These logs can be integrated into the claims file for use as part of the insurance coverage validation process and system.

Documents often need to be generated for use by the insurance claims handler for the validation of insurance coverage and processing of the claim. Such documents include reservation of rights letters, disclaimers or denials of coverage generated for use by the claims handler for the further processing of the claim. Additionally, letters can be generated to send to the insured, claimant or other interested persons or entities concerning the claim, such as an acknowledgement of the claim or request for additional information or documents, such as verification of facts needed for the validation of insurance coverage, authorizations for records required for the processing of the claim, such as medical authorizations, wage verifications or credit authorizations. Also, forms can be generated for a claims handler to use in the processing of the claim or for further completion by the insured, a claimant or other persons or entities concerning the claim. It should be further understood that such documents, rather than being generated or directly presented, are presented through links, such as an electronic hyperlink, to access the document or related material.

A sampling of case law, statutory or regulatory authority or other law or authority can also be generated. Additionally, a sampling of relevant legal literature relating to the subject claim and the issues involved therein. For example, the literature can include case law, statutory or regulatory law or authority or other law may be generated for use or reference by the claims handler or user. Copies of legal periodicals or literature can be generated in one embodiment. In one embodiment the user can go to a link to the case law, statutory or regulatory law or authority or periodical or other law for review or reference. In one embodiment the insurer's internal guidelines or procedures referable to the claim can be generated for reference by the user.

Additionally, information and/or advertising can be generated, for example reflecting services or products which may be useful in the processing of a claim, such as an investigative service that can assist with the further inquiries needed or a record retrieval service for documents needed in furtherance of the claim.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed:

1. A method of evaluating insurance coverage under a policy of insurance, the method comprising:
receiving first insurance claim information associated with an insurance claim, the first insurance claim information including a claimant identifier and a policy identifier, the policy identifier corresponding to at least one portion of an insurance policy;
outputting a representative portion of the insurance policy, the representative portion of the insurance policy selected by a computer processing device in response to the receipt of the first insurance claim information;
receiving second insurance claim information in response to the output representative portion of the insurance policy, the second insurance claim information associated with the insurance claim; and
generating an insurance coverage record based on the second insurance claim information and the insurance policy, wherein the insurance coverage record identifies whether there exists an issue needed to be resolved for the validation of insurance coverage and identifies if any issues exist.

2. The method of claim 1, wherein the first insurance claim information includes an indication of a type of claim to which the insurance claim applies.

3. The method of claim 1, wherein the representative portion of the insurance policy is rephrased and presented in the form of a question.

4. The method of claim 1, wherein the representative portion of the insurance policy includes at least one Exclusion, Term, Condition, Provision, Policy Endorsement or Definition, as reflected in the insurance policy.

5. The method of claim 1, wherein the representative portion of the insurance policy includes or incorporates at least one judicial decision, regulatory or statutory authority or guidelines pertaining to the insurance claim.

6. The method of claim 1, wherein the second insurance claim information is at least partially responsive to the rephrased output representative portion of the insurance policy.

7. The method of claim 1, wherein the generated insurance coverage record includes a warning or basis for denial of the insurance claim.

8. The method of claim 1, wherein the generated insurance coverage record indicates no valid basis for denial of the insurance claim.

9. The method of claim 1, wherein the generated insurance coverage record includes a list or summary of compiled details regarding the insurance claim.

10. The method of claim 9, wherein the list or summary identifies a form, document, or written communication needed for the validation of insurance coverage.

11. The method of claim 1, wherein the record includes actual copies of the needed form, document or written communication.

12. The method of claim 1, wherein the identified issue includes at least one factual issue or at least one legal issue for further inquiry or investigation.

13. The method of claim 1, wherein the identified issue includes a basis for consulting legal counsel.

14. The method of claim 1, wherein the insurance coverage record includes an assessment of the responses received from the queries.

15. The method of claim 14, wherein the assessment includes an indication of how the queries were answered.

16. The method of claim 1, wherein the insurance coverage record is used for auditing or monitoring the insurance claims representatives performance and evaluation of coverage under the insurance policy for a particular insurance claim.

17. The method of claim 1, wherein the insurance coverage record is used for training an insurance claims representative.

18. The method of claim 1, wherein the insurance coverage record is used for a different insurance claim.

19. The method of claim 1, wherein the insurance coverage record includes information based on a determination of at least one of legal precedent and guidelines altering the interpretation, at least in part, of a portion of the insurance policy.

20. A system to evaluate insurance coverage under a policy of insurance, the system comprising:
a computer processing device that
receives first insurance claim information associated with an insurance claim, the first insurance claim information including a claimant identifier and a policy identifier, the policy identifier corresponding to at least one portion of an insurance policy;
outputs a representative portion of the insurance policy, the representative portion of the insurance policy selected by the computer processing device in response to the receipt of the first insurance claim information;
receives second insurance claim information in response to the output representative portion of the insurance policy, the second insurance claim information associated with the insurance claim; and
generates an insurance coverage record based on the second insurance claim information and the insurance policy, wherein the insurance coverage record identifies whether there exists an issue needed to be resolved for the validation of insurance coverage and identifies if any issues exist.

21. The system of claim 20, wherein the first insurance claim information includes an indication of a type of claim to which the insurance claim applies.

22. The system of claim 20, wherein the representative portion of the insurance policy is rephrased and presented in the form of a question.

23. The system of claim 20, wherein the second insurance claim information is at least partially responsive to the rephrased output representative portion of the insurance policy.

24. The system of claim 20, wherein the generated insurance coverage record includes a warning or basis for denial of the insurance claim.

25. The system of claim 20, wherein the generated insurance coverage record includes a list or summary of compiled details regarding the insurance claim, wherein the list or summary identifies a form, document, or written communication needed for the validation of insurance coverage.

26. The system of claim 20, wherein the identified issue includes at least one factual issue or at least one legal issue for further inquiry or investigation.

27. The system of claim 20, wherein the insurance coverage record includes an assessment of the responses received from the queries.

28. The system of claim 20, wherein the insurance coverage record includes information based on a determination of at least one of legal precedent and guidelines altering the interpretation, at least in part, of a portion of the insurance policy.
